(19) United States
(12) Patent Application Publication
(10) Pub. No.: US 2026/0369077 A1
(43) Pub. Date: Nov. 19, 2026

(54) INFORMATION PROCESSING APPARATUS, INFORMATION PROCESSING METHOD, AND COMPUTER READABLE MEDIUM

(71) Applicant: NEC Corporation, Tokyo (JP)

(72) Inventor: Masataka NISHIDA, Tokyo (JP)

(73) Assignee: NEC Corporation, Tokyo (JP)

(21) Appl. No.: 19/132,430

(22) PCT Filed: Dec. 5, 2022
(86) PCT No.: PCT/JP2022/044666

§ 371 Date: May 23, 2025

(51) Int. Cl. G06V 20/56; G06V 10/25

(52) U.S. Cl. CPC G06V 20/588; G06V 10/25

(57) ABSTRACT

An information processing apparatus includes: a recognition unit configured to recognize an area of a division line on a road around a vehicle from a first image obtained by photographing the road; a generation unit configured to generate a second image on which the recognized area of the division line on the road is indicated in a coordinate plane in which a longitudinal direction and a lateral direction of the vehicle are defined as two axes; and an estimation unit configured to estimate a linear figure representing the division line on the road based on the second image.

### TECHNICAL FIELD

The present disclosure relates to an information processing apparatus, an information processing method, and a non-transitory computer readable medium storing a program.

### BACKGROUND ART

Patent Literature 1 discloses a technology for recognizing a division candidate closest to a vehicle among a plurality of division candidate as a candidate driving division line, in a case where there are a plurality of division candidates which are line candidates whose luminance is determined to be equal to or greater than a luminance threshold. It is disclosed that thus, it is possible to cope with a problem that only white lines are always recognized in a case where a plurality of line candidates having different luminance, such as white lines and yellow lines, are detected.

### CITATION LIST

### Patent Literature

Patent Literature 1: Japanese Unexamined Patent Application Publication No. 2019-20957

### SUMMARY OF INVENTION

### Technical Problem

However, in the technology disclosed in Patent Literature 1, for example, a division line (e.g., center line or a lane boundary line) indicating one side of the lane in which the vehicle is traveling may not be detected properly depending on the shape of the division line, for example, in a case where the division line is a broken line.

In view of the above-described problem, an object of the present disclosure is to provide an information processing apparatus, an information processing method, and a non-transitory computer readable medium storing a program capable of properly detecting a lane division line.

### Solution to Problem

In a first example aspect according to the present disclosure, an information processing apparatus includes: a recognition unit configured to recognize an area of a division line on a road around a vehicle from a first image obtained by photographing the road; a generation unit configured to generate a second image on which the recognized area of the division line on the road is indicated in a coordinate plane in which a longitudinal direction and a lateral direction of the vehicle are defined as two axes; and an estimation unit configured to estimate a linear figure representing the division line on the road based on the second image.

Further, in a second example aspect according to the present disclosure, an information processing method including: recognizing an area of a division line on a road around a vehicle from a first image obtained by photographing the road; generating a second image in which the recognized area of the division line on the road is indicated on a coordinate plane on which a longitudinal direction and a lateral direction of the vehicle are defined as two axes; and estimating a linear figure representing the division line on the road based on the second image.

Further, in a third example aspect according to the present disclosure, a non-transitory computer readable medium storing a program for causing a computer to execute processes including: recognizing an area of a division line on a road around a vehicle from a first image obtained by photographing the road; generating a second image in which the recognized area of the division line on the road is indicated on a coordinate plane on which a longitudinal direction and a lateral direction of the vehicle are defined as two axes; and estimating a linear figure representing the division line on the road based on the second image.

### Advantageous Effects of Invention

According to an example aspect of the present disclosure, a lane division line can be properly detected.

### BRIEF DESCRIPTION OF DRAWINGS

FIG. 1 is a diagram showing an example of a configuration of an information processing apparatus according to an example embodiment;

FIG. 2 is a diagram showing an example of a hardware configuration of an information processing apparatus according to an example embodiment;

FIG. 3 is a flowchart showing an example of processes performed by an information processing apparatus according to an example embodiment;

FIG. 4 is a diagram showing an example of a photographed image according to an example embodiment;

FIG. 5 is a diagram showing an example of a photographed image after threshold processing according to an example embodiment;

FIG. 6 is a diagram showing an example of a binarized image in which a broken line part of a division line is detected according to an example embodiment;

FIG. 7 is a diagram showing an example of a broken line of a division line on a bird's-eye view according to an example embodiment;

FIG. 8 is a diagram showing an example of a lane on a bird's-eye view according to an example embodiment; and

FIG. 9 is a diagram showing an example of an output image according to an example embodiment.

### EXAMPLE EMBODIMENT

The principle of the present disclosure will be described with reference to some illustrative example embodiments. It should be understood that these example embodiments are described for illustrative purposes only and will assist those skilled in the art in understanding and implementing the present disclosure without suggesting any limitations with regard to the scope of the present disclosure. The disclosure described herein is implemented in various ways other than those described below.

In the following description and claims, unless otherwise defined, the meanings of all technical and scientific terms used herein are the same as those generally understood by those skilled in the art to which the present disclosure pertains.

Example embodiments according to the present disclosure will be described below with reference to the drawings.

### First Example Embodiment

### <Configuration>

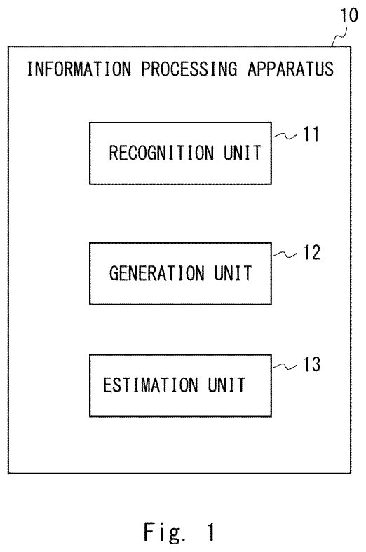

A configuration of an information processing apparatus 10 according to an example embodiment will be described with reference to FIG. 1. FIG. 1 is a diagram showing an example of the configuration of the information processing apparatus 10 according to an example embodiment. The information processing apparatus 10 includes a recognition unit 11, a generation unit 12, and an estimation unit 13.

These units may be implemented by one or more programs installed in the information processing apparatus 10 and hardware of the information processing apparatus 10 such as a processor and a memory as they operate in cooperation with each other.

The recognition unit 11 recognizes an area of a division line on a road around the vehicle from a first image obtained by photographing the road. The generation unit 12 generates a second image in which the area of the division line on the road recognized by the recognition unit 11 is indicated on a coordinate plane on which the longitudinal direction (e.g., forward direction) and the lateral direction of the vehicle are defined as two axes. The estimation unit 13 estimates a linear figure representing the division line on the road based on the second image.

### Second Example Embodiment

### <Hardware Configuration>

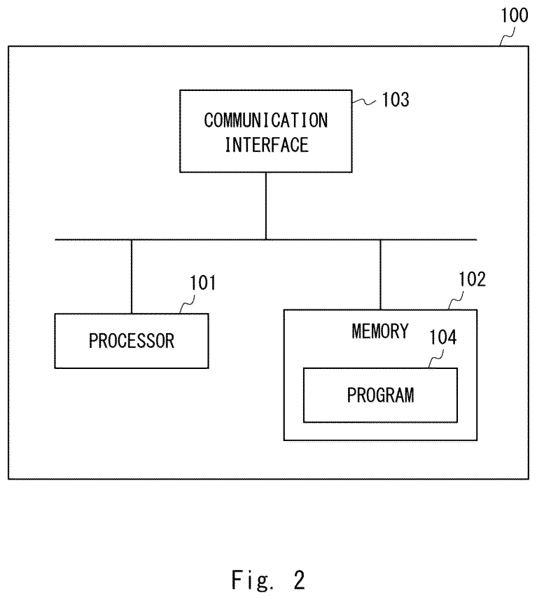

FIG. 2 is a diagram showing an example of a hardware configuration of the information processing apparatus 10 according to the example embodiment. In the example shown in FIG. 2, the information processing apparatus 10 (computer 100) includes a processor 101, a memory 102, and a communication interface 103. These components may be connected to each other by a bus or the like. The memory 102 stores at least a part of a program 104. The communication interface 103 includes an interface required for communication with other network elements.

If the program 104 is executed in cooperation with the processor 101, the memory 102 and the like, the computer 100 performs at least some of the processes of the example embodiments according to the present disclosure. The memory 102 may be of any type.

The memory 102 may, as a non-limiting example, be a non-transitory computer readable storage medium. Further, the memory 102 may be implemented using any suitable data storage technology, such as a semiconductor-based memory device, a magnetic memory device and system, an optical memory device and system, a fixed memory, and a removable memory. Although only one memory 102 is shown in the computer 100, the computer 100 may include several memory modules that are physically different from each other. The processor 101 may be of any type. The processor 101 may include one or more of a general-purpose computer, a dedicated computer, a microprocessor, a Digital Signal Processor (DSP), and a processor based on a multi-core processor architecture as a non-limiting example. The computer 100 may include a plurality of processors, such as an application-specific integrated circuit chip that is temporally dependent on a clock that synchronizes the main processor.

Example embodiments according to the present disclosure may be implemented in hardware or a dedicated circuit, software, logic, or any combination thereof. Some example aspects may be implemented in hardware, while other example aspects may be implemented in firmware or software that may be executed by a controller, a microprocessor, or other computing devices.

The present disclosure also provides at least one computer program product that is tangibly stored in a non-transitory computer readable storage medium. The computer program product includes computer executable instructions, such as instructions included in program modules, and is executed on a device on a target real or virtual processor to perform the processes or the method according to the present disclosure. The program modules include routines, programs, libraries, objects, classes, components, data structures, and the like that perform specific tasks or implement specific abstract data types. The functions of the program modules may be combined or divided among the program modules as desired in various example embodiments. Machine executable instructions for the program modules can be executed in a local or a distributed device. In a distributed device, program modules can be located in both local and remote storage media.

Program codes for performing the method according to the present disclosure may be written in any combination of one or more programming languages. These program codes are provided to a processor or a controller of a general-purpose computer, a dedicated computer, or other programmable data processing apparatuses. If the program codes are executed by the processor or the controller, functions/operations in the flowchart and/or a block diagram to be implemented are executed. The program codes are executed entirely on a machine, partly on a machine, as a stand-alone software package, partly on a machine, partly on a remote machine, or entirely on a remote machine or a server.

The program can be stored and provided to a computer using any type of non-transitory computer readable media. Non-transitory computer readable media include any type of tangible storage media.

Examples of non-transitory computer readable media include magnetic storage media, optical magnetic storage media, optical disc media, semiconductor memories, and the like. Magnetic storage media include, for example, flexible disks, magnetic tapes, hard disk drives, and the like. Optical magnetic storage media include, for example, magneto-optical disks and the like. Optical disk media include, for example, a Blu-ray disc, a Compact Disc (CD)-Read Only Memory (ROM), a CD-Recordable (R), a CD-ReWritable (RW), and the like. Semiconductor memories include, for example, a mask ROM, a Programmable ROM (PROM), an Erasable PROM (EPROM), a flash ROM, a random access memory (RAM), and the like. The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires and optical fibers) or a wireless communication line.

### <Processing>

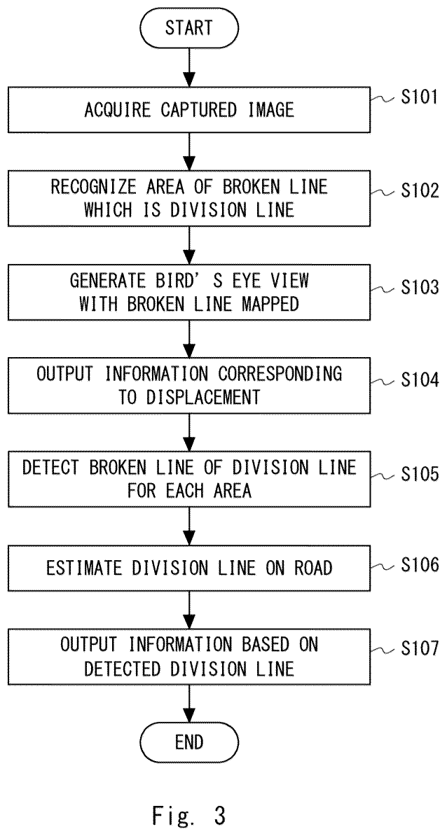

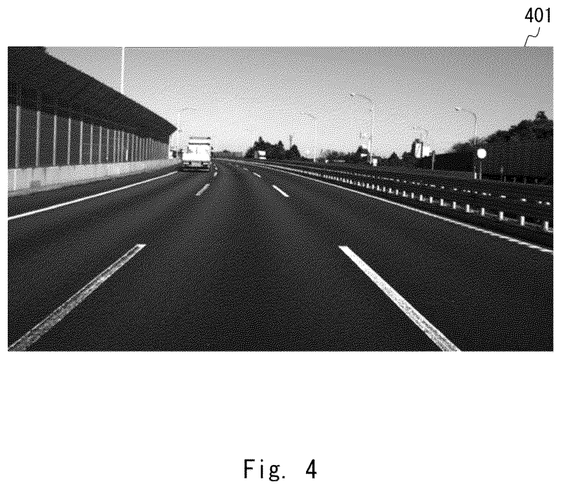

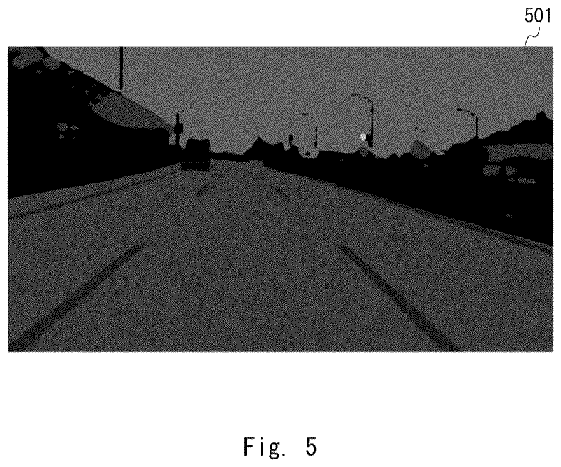

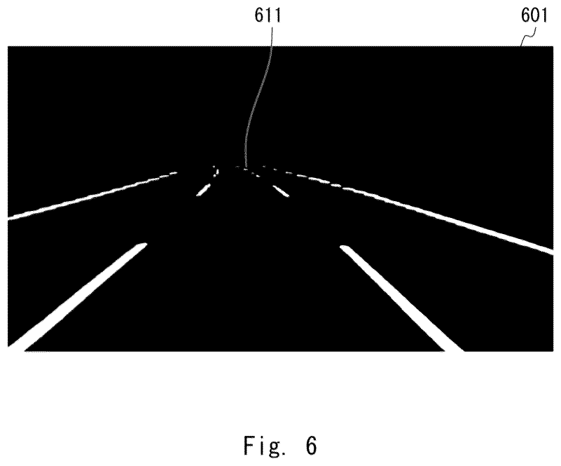

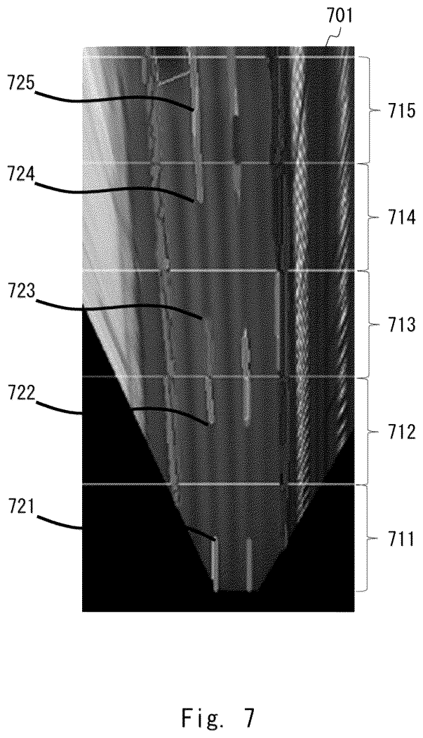

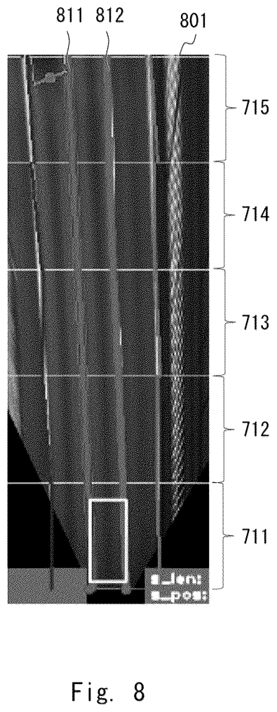

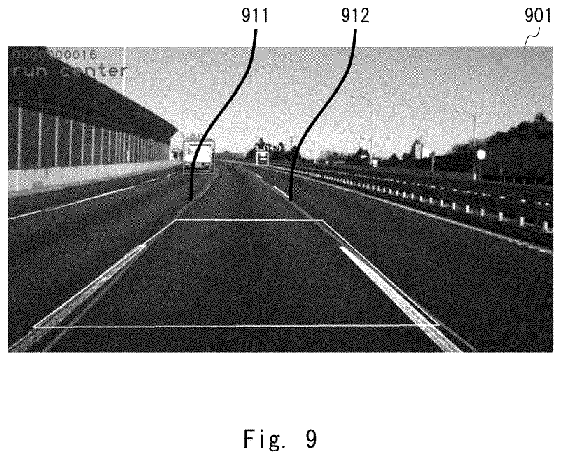

Next, with reference to FIGS. 3 to 9, an example of the processing of the information processing apparatus 10 according to the example embodiment will be described. FIG. 3 is a flowchart showing an example of the processing of the information processing apparatus 10 according to the example embodiment. FIG. 4 is a diagram showing an example of a photographed image according to the example embodiment. FIG. 5 is a diagram showing an example of a photographed image after threshold processing according to the example embodiment. FIG. 6 is a diagram showing an example of a binarized image in which the broken line part of the division line is detected according to the example embodiment. FIG. 7 is a diagram showing an example of a broken line of the division line on a bird's-eye view according to the example embodiment. FIG. 8 is a diagram showing an example of a lane on a bird's-eye view according to the example embodiment. FIG. 9 is a diagram showing an example of an output image according to the example embodiment.

In a step S101, the recognition unit 11 acquires a still image (first image) photographed by the camera. Note that, for example, the recognition unit 11 may acquire one frame of a moving image photographed by a monocular camera mounted on the vehicle. In the example shown in FIG. 4, the recognition unit 11 acquires an image 401 obtained by photographing the road in the forward direction (the traveling direction if traveling straight) of the vehicle (hereinafter also referred to as an “own vehicle” as appropriate) mounted with camera.

Next, the recognition unit 11 recognizes an area of a broken line which is a division line (e.g., a center line, a lane boundary line) indicating one side of the lane on the road in the area in the first image obtained by photographing the road in front of the own vehicle (step S102). Note that, for example, the recognition unit 11 may perform threshold processing based on the luminance of each pixel. In this case, for example, the recognition unit 11 may convert the value of a pixel having luminance in a specific range into a specific color. Thus, for example, unnecessary background information can be deleted, and the outline can be emphasized. Then, for example, the recognition unit 11 may recognize the area of the broken line, which is the division line, based on the outline or the like of the area in the image.

In the example shown in FIG. 5, an image 501 is generated by subjecting the photographed image 401 of FIG. 4 to threshold processing, in which the outline of the area of the broken line, which is the division line, is emphasized. In the example shown in FIG. 6, a binarized image 601 in which the area of the broken line of the division line is distinguished from other areas is generated based on an image 501 of FIG. 5.

Next, the generation unit 12 generates a bird's-eye view (bird's-eye view. “a second image”) in which the recognized broken lines are mapped while using the forward and horizontal directions of the own vehicle as two axes, based on the result of the recognition by the recognition unit 11 (step S103). Note that, the generation unit 12 generates a bird's-eye view in which values represented by using the two axes are values corresponding to the distances from the own vehicle represented by using the respective directions of the two axes in a real space. The bird's-eye view may be, for example, a vertically downward view or an obliquely downward view from above the vehicle.

Note that, for example, the generation unit 12 may generate the bird's-eye view by converting the coordinates of the pixels within the area of the broken line of the division line on the photographed image into the coordinates in the bird's-eye view. In this case, for example, if the camera is installed in the own vehicle by an operator, it may be installed so that the optical axis direction of the camera (center of the image) coincides with the forward direction of the own vehicle. Further, information of shooting conditions such as the camera's angle of view may be registered in the information processing apparatus by the operator. Then, for example, the generation unit 12 may determine a formula for converting the coordinates of each pixel in the photographed image into the position in the forward direction of the own vehicle and the position in the horizontal direction in the real space based on the information of shooting conditions such as the camera's angle of view.

Further, for example, if the camera is installed in the own vehicle by the operator, positions for each coordinate of a plurality of points in the photographed image in the forward direction and in the horizontal direction of the own vehicle in the real space may be registered. In this case, for example, the plurality of points may be four corners of a trapezoidal shape of which the upper bottom corresponds to the far end in the forward direction of the vehicle and the lower bottom corresponds to the near end in the forward direction, and the upper bottom is shorter than the lower bottom. Then, for example, the generation unit 12 may determine a formula for converting the coordinates of each pixel in the photographed image into a position in the forward direction and in the horizontal direction of the own vehicle in the real space based on information in which the coordinates of each point in the photographed image are associated with a position in the forward direction and in the horizontal direction of the own vehicle in the real space.

For example, if a line segment of a division line is detected using the coordinates in the photographed image as shown in FIG. 6, a line segment of a division line at a position relatively far from the vehicle (e.g., line segment 611) is mapped into a shape close to a point. Therefore, if a line segment is detected using the coordinates in the photographed image by Hough Transformation for example, there may be a problem in the detection accuracy of a line segment of a division line at a position relatively far from the own vehicle. In contrast, according to the present disclosure, since the coordinates in the photographed image are converted into the coordinates in the bird's-eye view and then the line segments are detected by Hough Transformation, for example, the detection accuracy of the line segments of the division lines located relatively far from the own vehicle can be improved.

Next, the estimation unit 13 divides the bird's-eye view into a plurality of areas according to the distance in the forward direction of the vehicle (Step S104). Note that, for example, the estimation unit 13 may divide the bird's-eye view into a first area including a range shorter than the specified distance in the forward direction of the own vehicle and a second area including a range longer than the specified distance in the forward direction of the own vehicle.

In the example of FIG. 7, the estimation unit 13 divides the bird's-eye view 701 into areas 711, 712, 713, 714 and 715 in ascending order of the distance from the own vehicle at specified intervals (e.g., 10 meters) according to the distance in the forward direction of the own vehicle.

Next, the generation unit 12 detects a line segment of a division line for each area of the bird's-eye view (step S105). Here, for example, the generation unit 12 may detect a line segment of a division line for each area by executing Hough Transformation for each area. It should be noted that the transformation by the generation unit 12 is not limited to Hough Transformation, and it may detect a line segment using other known techniques.

Subsequently, the estimation unit 13 estimates a linear figure representing a division line on the road based on the line segments detected in each area (step S106). Here, for example, the estimation unit 13 may estimate a line passing through a position on a first line segment detected in the first area and a position on the second line segment detected in the second area as one side of the lane on the road. Thus, for example, even if the road ahead of the own vehicle is curved, the detection accuracy of the linear figure representing the curved division line can be improved.

In this case, for example, the estimation unit 13 may detect a straight line passing through a specific point in the line segments detected in each area as one side of the lane. The specific point may be, for example, a point on the line segment at a position closest to the middle in the forward direction of the own vehicle in each area. In this case, in the example of FIG. 7, straight lines passing through points 721, 722, 723, 724, and 725 on the line segment at a position closest to the middle in the forward direction (longitudinal direction in FIG. 7) of the vehicle in the respective areas 711, 712, 713, 714, and 715 are detected as one side of the lane on the road. Thus, as shown in the bird's-eye view 801 of FIG. 8, for example, a line 811 at the left end and a line 812 at the right end of the driving lane of the own vehicle are detected.

The estimation unit 13 may estimate a linear figure representing a division line on the road based on a line segment satisfying a predetermined angle condition among the plurality of detected line segments. In this case, among the plurality of detected line segments in the second area, the estimation unit 13 may determine a line segment satisfying a predetermined condition for the angle from the direction in which the first line segment detected in the first area extends toward the second area as the second line segment, which forms the same side as one side of the lane defined by the first line segment. Thus, for example, even if the road ahead of the own vehicle is curved, the detection accuracy of the line segment of the curved division line can be improved. In this case, the estimation unit 13 may determine among the plurality of detected line segments in the second area, as the second line segment, a line segment existing within a specific angle (e.g., 15 degrees) centered on the direction in which the first line segment extends toward the second area from one of both ends of the first line segment closer to the second area. In addition, for example, the estimation unit 13 may determine the reliability of the estimation of the specific line segment to be higher, if another line segment satisfying the predetermined angle condition is detected for this specific line segment.

In addition, if the width of detected lane on the road is shorter than a threshold, the estimation unit 13 may detect (correct, modify) a line of a specific width from the line, among the lines determined as the lines on both sides of the lane, on one side of the lane based on the line segment having a higher reliability of the detection of the line segment by the Hough Transformation as the line on the other side of the lane. Thus, for example, this can improve the detection accuracy of the lane located relatively far from the own vehicle. In this case, for example, in the Hough Transformation, the estimation unit 13 may first project the coordinates (x, y) of each pixel on the line segment of the division line in the bird's-eye view to a point (ρ, θ) having a distance ρ and an angle θ in the polar coordinate two-dimensional space (coordinate transformation). Here, the distance ρ may be, for example, the length of the perpendicular line of the straight line passing through the coordinates (x, y) extending from the origin. In addition, the angle θ may be, for example, an angle formed between the perpendicular line of the straight line passing through the coordinates (x, y) extending from the origin and the x-axis. Then, for example, the estimation unit 13 may detect, a line segment in the xy coordinate system in the bird's eye view based on the projected points (ρ, θ). Then, for example, the estimation unit 13 may determine the reliability for the line segment in the xy coordinate system in the bird's eye view detected based on the projected points (ρ, θ) in such a manner that the larger the number of projected points (ρ, θ) are, the higher the reliability becomes.

In addition, the estimation unit 13 may calculate the reliability of the estimation of the linear figure representing the estimated division line on the road, and specify a linear figure representing two division lines forming both ends of the lane on the road based on the calculated reliability. Further, for example, if the camera mounted on the vehicle continuously captures images, the estimation unit 13 may determine the reliability for the linear figure estimated in the current frame, in such a manner that the shorter the distance between the linear figure representing the division line estimated in a previous frame and the linear figure estimated in the current frame is, the higher the reliability for the linear figure estimated in the current frame becomes.

Further, the estimation unit 13 may calculate the width between the linear figures representing the estimated division lines on the road, and calculate the reliability based on a comparison between the calculated width and a predetermined reference value representing the width of the lane on the road (width of the road). In this case, for example, the estimation unit 13 may determine, if another line segment parallel to the detected specific line segment is detected at a position the predetermined reference value apart from the specific line segment, the reliability for the specific line segment to be higher. Then, the estimation unit 13 may estimate the division line forming the left end of the lane on the road in each area based on the linear figure having the highest reliability among the linear figures within a first lateral distance (e.g., within a lateral distance of 3 meters to the left of the center of the vehicle). In addition, similarly, the estimation unit 13 may estimate the division line forming the right end of the lane on the road in each area based on the linear figure having the highest reliability among the linear figures within a second lateral distance (e.g., within a lateral distance of 3 meters to the right of the center of the vehicle).

Subsequently, the estimation unit 13 outputs information based on the estimated division line on the road (step S107). Here, for example, the estimation unit 13 may output information indicating the distance from one end side of the driving lane of the own vehicle to the own vehicle. In addition, for example, as shown in FIG. 9, the estimation unit 13 may output an image in which lines on both sides of the driving lane of the own vehicle are superimposed on the photographed image. In Example of FIG. 9, an image 901 in which lines 911 and 912 in the coordinates of the photographed image which are respectively obtained by converting the coordinates of the line 811 at the left end and the line 812 at the right end of the driving lane of the own vehicle in the bird's-eye view shown in FIG. 8 are superimposed on the captured image 401 shown in FIG. 4.

Thus, for example, it is possible to support the generation of simulation data for the development of an automated driving system that imitates the wobble of the actually driven own vehicle, or a driving support system. Further, for example, it is possible to support the operation verification of the own vehicle equipped with the automated driving system or the driving support system if the own vehicle is actually driven. Furthermore, for example, it is possible to detect the driving lane of the own vehicle equipped with the automated driving system or the driving support system if the own vehicle is actually driven.

### Modified Example

The information processing apparatus 10 may be an apparatus included in a single housing, but the information processing apparatus 10 according to this disclosure is not limited thereto. Each unit of the information processing apparatus 10 may be implemented, for example, by cloud computing composed of one or more computers. The above-described information processing apparatus 10 is also included in examples of the “information processing apparatus” according to the present disclosure.

Note that the present disclosure is not limited to the above-described embodiments and may be changed as appropriate without departing from the scope and spirit of the present invention.

The whole or part of the example embodiments disclosed above can be described as, but not limited to, the following supplementary notes.

### (Supplementary Note 1)

An information processing apparatus comprising:
a recognition unit configured to recognize an area of a division line on a road around a vehicle from a first image obtained by photographing the road;
a generation unit configured to generate a second image on which the recognized area of the division line on the road is indicated in a coordinate plane in which a longitudinal direction and a lateral direction of the vehicle are defined as two axes; and
an estimation unit configured to estimate a linear figure representing the division line on the road based on the second image.

### (Supplementary Note 2)

The information processing apparatus described in Supplementary note 1, wherein the estimation unit detects a plurality of line segments based on the area of the division line on the road indicated in the second image, and estimates a linear figure representing the division line on the road based on the plurality of detected line segments.

### (Supplementary Note 3)

The information processing apparatus described in Supplementary note 2, wherein the estimation unit divides the second image into a first area including a range shorter than a predetermined distance in the longitudinal direction of the vehicle and a second area including a range longer than the predetermined distance in the longitudinal direction of the vehicle, and estimates a linear figure representing the division line on the road based on the first line segment detected in the first area and the second line segment detected in the second area.

### (Supplementary Note 4)

The information processing apparatus described in Supplementary note 2 or 3, wherein the estimation unit estimates a linear figure representing the division line on the road based on a line segment satisfying a predetermined angle condition among the plurality of detected line segments.

### (Supplementary Note 5)

The information processing apparatus described in Supplementary note 3, wherein the estimation unit determines a second line segment forming a linear figure representing the same division line as the first line segment among the plurality of detected line segments in the second area based on a direction in which the first line segment extends toward the second area.

### (Supplementary Note 6)

The information processing described in Supplementary note 2 or 3, wherein the estimation unit calculates a reliability of estimation for the estimated linear figure representing the division line on the road, and specifies a linear figure representing two division lines forming both ends of a lane on the road based on the calculated reliability.

### (Supplementary Note 7)

The information processing apparatus described in Supplementary note 6, wherein the estimation unit calculates a width between the estimated linear figures representing the division lines of the lane on the road, and calculates the reliability based on a comparison of the calculated width with a predetermined reference value representing the width of the lane on the road.

### (Supplementary Note 8)

An information processing method comprising:
recognizing an area of a division line on a road around a vehicle from a first image obtained by photographing the road;
generating a second image in which the recognized area of the division line on the road is indicated on a coordinate plane on which a longitudinal direction and a lateral direction of the vehicle are defined as two axes; and
estimating a linear figure representing the division line on the road based on the second image.

### (Supplementary Note 9)

A non-transitory computer-readable medium storing a program that causes a computer to execute a process comprising:
recognizing an area of a division line on a road around a vehicle from a first image obtained by photographing the road;
generating a second image in which the recognized area of the division line on the road is indicated on a coordinate plane on which a longitudinal direction and a lateral direction of the vehicle are defined as two axes; and
estimating a linear figure representing the division line on the road based on the second image.

### REFERENCE SIGNS LIST

1 MONITORING SYSTEM
10 INFORMATION PROCESSING APPARATUS
11 RECOGNITION UNIT
12 GENERATION UNIT
13 ESTIMATION UNIT

What is claimed is:

1. An information processing apparatus comprising:
a memory configured to store instructions; and
a processor configured to execute the instructions to:
recognize an area of a division line on a road around a vehicle from a first image obtained by photographing the road;
generate a second image on which the recognized area of the division line on the road is indicated in a coordinate plane in which a longitudinal direction and a lateral direction of the vehicle are defined as two axes; and
estimate a linear figure representing the division line on the road based on the second image.

2. The information processing apparatus according to claim 1,
wherein the processor is configured to execute the instructions to detect a plurality of line segments based on the area of the division line on the road indicated in the second image, and estimate a linear figure representing the division line on the road based on the plurality of detected line segments.

3. The information processing apparatus according to claim 2,
wherein the processor is configured to execute the instructions to divide the second image into a first area including a range shorter than a predetermined distance in the longitudinal direction of the vehicle and a second area including a range longer than the predetermined distance in the longitudinal direction of the vehicle, and estimate a linear figure representing the division line on the road based on the first line segment detected in the first area and the second line segment detected in the second area.

4. The information processing apparatus according to claim 2,
wherein the processor is configured to execute the instructions to estimate a linear figure representing the division line on the road based on a line segment satisfying a predetermined angle condition among the plurality of detected line segments.

5. The information processing apparatus according to claim 3,
wherein the processor is configured to determine a second line segment forming a linear figure representing the same division line as the first line segment among the plurality of detected line segments in the second area based on a direction in which the first line segment extends toward the second area.

6. The information processing apparatus according to claim 2,
wherein the processor is configured to calculate a reliability of estimation for the estimated linear figure representing the division line on the road, and specify a linear figure representing two division lines forming both ends of a lane on the road based on the calculated reliability.

7. The information processing apparatus according to claim 6,
wherein the processor a width between the estimated linear figures representing the division lines of the lane on the road, and calculates the reliability based on a comparison of the calculated width with a predetermined reference value representing the width of the lane on the road.

8. An information processing method to:
recognizing an area of a division line on a road around a vehicle from a first image obtained by photographing the road;
generating a second image in which the recognized area of the division line on the road is indicated on a coordinate plane on which a longitudinal direction and a lateral direction of the vehicle are defined as two axes; and
estimating a linear figure representing the division line on the road based on the second image.

9. A non-transitory computer-readable medium storing a program that causes a computer to execute a process comprising:
recognizing an area of a division line on a road around a vehicle from a first image obtained by photographing the road;
generating a second image in which the recognized area of the division line on the road is indicated on a coordinate plane on which a longitudinal direction and a lateral direction of the vehicle are defined as two axes; and
estimating a linear figure representing the division line on the road based on the second image.
